(19) United States
(12) Patent Application Publication
(10) Pub. No.: US 2005/0225993 A1
(43) Pub. Date: Oct. 13, 2005

(54) Plated synthetic resin member for vehicle

(75) Inventors: Akira Yamazaki, Gunma (JP); Naoki Sakamoto, Gunma (JP); Hideaki Kosuge, Gunma (JP); Yasufumi Sugauchi, Gunma (JP); Junichi Togasaki, Gunma (JP); Akira Sakurai, Saitama (JP)

Correspondence Address: ARENT FOX PLLC, 1050 CONNECTICUT AVENUE, N.W., SUITE 400, WASHINGTON, DC, 20036, US

(73) Assignees: MORIROKU KABUSHIKI KAISHA OHRA SANGYO CORPORATION; ADVANCE CO., LTD.

(21) Appl. No.: 11/148,258

(22) Filed: Jun. 9, 2005

Related U.S. Application Data
(63) Continuation of application No. 10/074,255, filed on Feb. 14, 2002.

(30) Foreign Application Priority Data
Feb. 15, 2001 (JP) 2001-039094

(51) Int. Cl. F21V 1/00

(52) U.S. Cl. 362/488; 362/509

(57) ABSTRACT

A plated synthetic resin member for a vehicle has a main body made of a synthetic resin and a plating coat formed on the surface of the main body and having a metallic gloss. The main body is molded from a translucent synthetic resin. The plating coat formed on the surface of the main body is translucent. The main body has a built-in lamp that can light up. Lighting up the lamp at night puts the plating coat in a light-emitting state. Thus, the plated synthetic resin member for a vehicle that can provide a high-class image even at night.

### CROSS-REFERENCE TO RELATED APPLICATION

This is a Continuation Application which claims the benefit of pending U.S. patent application Ser. No. 10/074,255, filed Feb. 14, 2002. The disclosure of the prior application is hereby incorporated herein in its entirety by reference.

### BACKGROUND OF THE INVENTION

1. Field of the Invention

The present invention relates to a plated synthetic resin member for a vehicle in which a plating coat having a metallic gloss is formed on the surface of the main body of a member made of a synthetic resin.

2. Description of the Related Art

Recently, in order to impart a high-class image to an automobile, etc., plated synthetic resin members whose surfaces have a plating coat with a metallic gloss have been widely used for both the interior and the exterior.

However, such conventional plated synthetic resin members cannot provide the purposely imparted high-class image at night unless light is reflected from the plating coat.

### SUMMARY OF THE INVENTION

The present invention has been achieved in view of the above-mentioned circumstances, and it is an object of the present invention to provide a plated synthetic resin member for a vehicle that can give a high-class image even at night.

In order to accomplish the above-mentioned object, in accordance with a first aspect of the present invention, there is proposed a plated synthetic resin member for a vehicle including a main body made of a synthetic resin and a plating coat formed on the surface of the main body and having a metallic gloss, wherein the main body is molded from a translucent synthetic resin, the plating coat formed on the surface of the main body is translucent, and the main body has a built-in lamp that can light up. The plated member corresponds to a lock release lever 3 and an operating knob 15 in embodiments of the present invention which will be described below, and the main body corresponds to a lever main body 5 and a knob main body 15.

In accordance with the above-mentioned first aspect, since the plating coat formed on the surface of the translucent main body is translucent, it gives off a metallic gloss during the day, thereby providing a high-class image for the member. Furthermore, lighting the lamp within the member at night puts the plating coat in a light-emitting state, thereby maintaining the high-class image of the member.

Furthermore, in addition to the above-mentioned first aspect, in accordance with a second aspect of the present invention, there is proposed a plated synthetic resin member for a vehicle, wherein the main body is an operating main body that is operated manually. The operating main body corresponds to a lever main body 5 and a knob main body 15 in the embodiments of the present invention that will be described below.

In accordance with the above-mentioned second aspect, lighting the lamp within the operating main body at night can put the plating coat in a light-emitting state, thus informing an occupant, etc. of the presence of the operating main body, thereby enhancing the manual operability.

The above-mentioned object, other objects, characteristics and advantages of the present invention will become apparent from explanations of preferred embodiments that will be described in detail below by reference to the appended drawings.

### BRIEF DESCRIPTION OF THE DRAWINGS

FIGS. 1 and 2 show a first embodiment of the present invention.

FIG. 1 is a perspective view of a lock release lever system on the inside of a door of an automobile.

FIG. 2 is a cross section at line 2-2 in FIG. 1.

FIGS. 3 to 5 show a second embodiment of the present invention.

FIG. 3 is a perspective view of an air-conditioner outlet vent device of an automobile.

FIG. 4 is a perspective view of an essential part of the same device.

FIG. 5 is a cross section at line 5-5 in FIG. 4.

### DESCRIPTION OF PREFERRED EMBODIMENTS

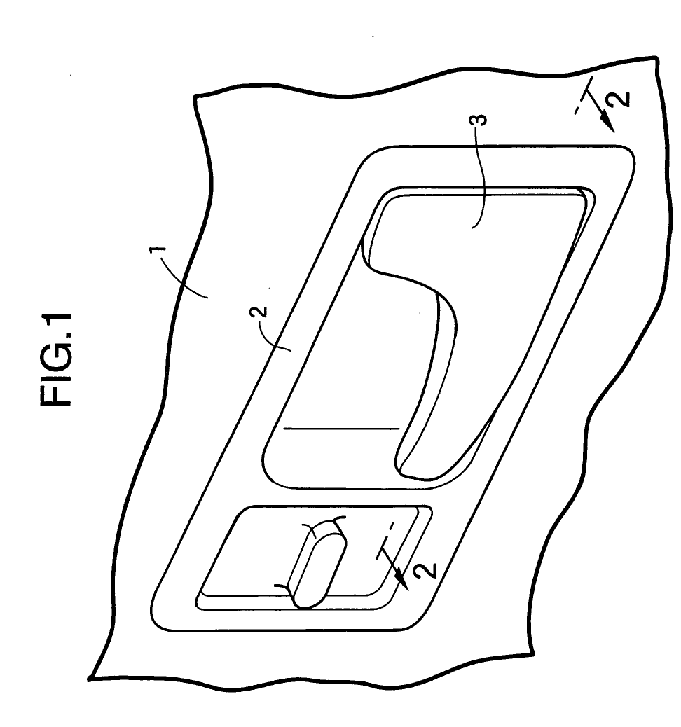

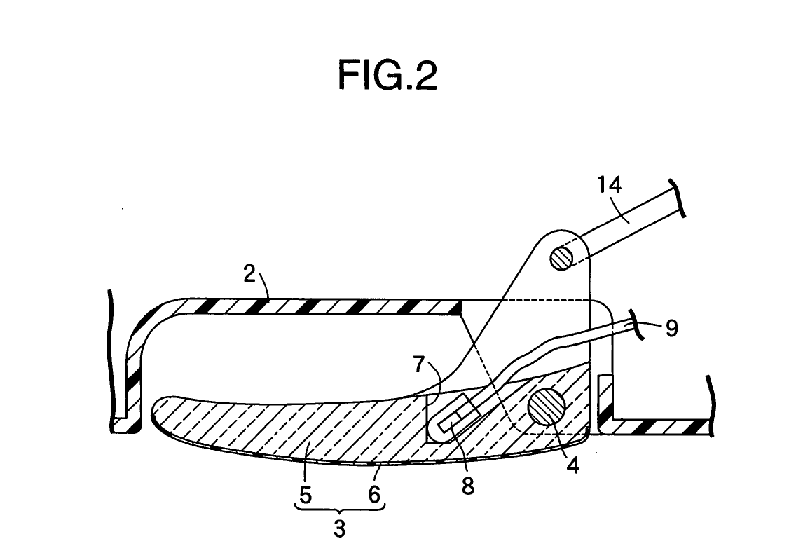

A first embodiment of the present invention is explained below by reference to FIGS. 1 and 2.

In FIGS. 1 and 2, the inner wall of a door 1 of an automobile is equipped with a lever housing 2. This lever housing 2 houses a lock release lever 3. This lock release lever 3 is swingably mounted in the lever housing 2 via a pivot 4, and is coupled to a link 14 that is connected to a door lock system (not illustrated). Pulling the link 14 can release the locked state of the door lock system.

The lock release lever 3 is formed from a lever main body 5 made of a translucent synthetic resin such as, for example, polycarbonate, acrylic, or ABS, and a plating coat 6 having a metallic gloss, which is formed on the surface of the lever main body 5 that faces the vehicle compartment.

One method of forming the translucent plating coat 6 is explained below. Firstly, a primer is applied on the surface of the lever main body 5. Subsequently, a silver mirror liquid containing silver nitrate, a reducing agent, etc. is applied on the surface. Effecting a silver mirror reaction forms a silver mirror coating, that is, the plating coat 6 on the lever main body 5. This plating coat 6 is very thin and can transmit light.

A recess 7 is formed on the reverse side of the lever main body 5. Mounted in the recess 7 is a lamp 8 formed from an LED, etc. The lamp 8 is connected to a lighting switch (not illustrated) via a lead wire 9, and is lit together with headlights at night.

Since the lock release lever 3 has the plating coat 6 formed on the surface thereof, it can give off a metallic gloss during the day, thereby providing a high-class image.

At night, since the lever main body 5 and plating coat 6 forming the lock release lever 3 are translucent, lighting the lamp 8 within the lock release lever 3 makes the light pass through the lock release lever 3, thereby putting the plating coat 6 in a light-emitting state. Such light emission of the plating coat 6 can maintain the high-class image of the lock release lever 3, and inform an occupant, etc. of the presence of the lock release lever 3, thereby enhancing the manual operability of the lock release lever 3.

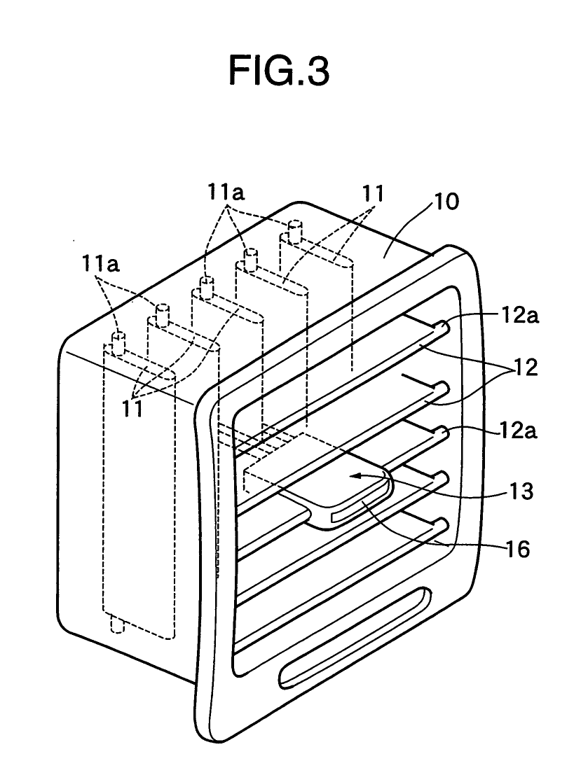

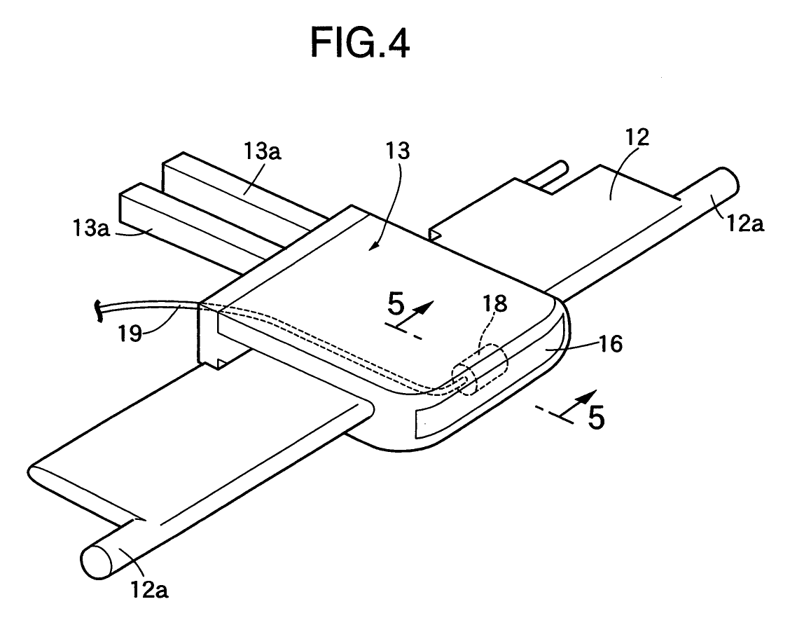

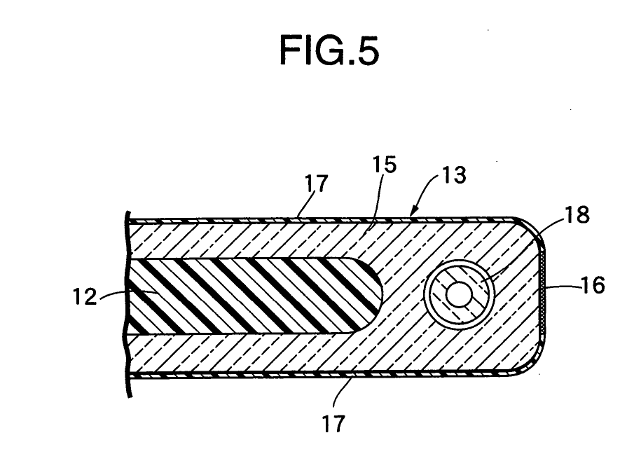

Next, the second embodiment of the present invention is explained by reference to FIGS. 3 to 5.

An air-conditioner outlet vent device for an automobile is formed from a synthetic resin housing 10 mounted in an instrument panel (not illustrated), and groups of vertical blades 11 and transverse blades 12, which are both made of a synthetic resin and are arranged within the housing 10 in a fore-and-aft manner along the flow direction of the air-conditioner air. Integrally provided on opposite ends in the longitudinal direction of each of the vertical blades 11 are support shafts 11a which are rotatably fitted in the housing 10. The vertical blades 11 are linked to each other via an operating link (not illustrated) so that the group of vertical blades 11 moves in unison. Integrally provided on opposite ends in the longitudinal direction of each of the transverse blades 12 are support shafts 12a which are rotatably fitted in the housing 10. The transverse blades 12 are linked to each other via an operating link (not illustrated) so that the group of transverse blades 12 moves in unison.

A synthetic resin operating knob 13 is slidably fitted around the outer periphery of the middle section, in the longitudinal direction, of one of the transverse blades 12. Vertically operating the operating knob 13 can swing the group of transverse blades 12 in unison, thereby adjusting, along the vertical direction, the direction in which the air-conditioner air blows out. The operating knob 13 has a pair of left and right connecting arms 13a that grip the forward end of one of the vertical blades 11. Sliding the operating knob 13 laterally on the transverse blade 12 can swing the group of vertical blades 11 in unison, thereby adjusting, along the lateral direction, the direction in which the air-conditioner air blows out.

The above-mentioned operating knob 13 is formed from a knob main body 15 made of a translucent synthetic resin material, a translucent plating coat 16 formed on the front face of the knob main body 15 that faces an occupant, and a light-shielding coating 17 formed on parts of the outer surface of the knob main body 15 other than the front face. Within the knob main body 15, there is embedded a lamp 18 formed from an LED, etc. This lamp 18 is connected to a lighting switch (not illustrated) via a lead wire 19, and is lit together with headlights at night.

Since the operating knob 13 has the plating coat 16 on the surface of the knob main body 15, it can give off a metallic gloss during the day, thereby providing a high-class image for the operating knob 13.

At night, since the knob main body 15 and the plating coat 16 on the front face of the knob main body 15 are translucent, lighting the lamp 18 within the operating knob 13 makes the light pass through the operating knob 13, thereby putting the plating coat 16 in a light-emitting state. Such light emission from the plating coat 16 can maintain the high-class image of the operating knob 13 and also inform an occupant, etc. of the presence of the operating knob 13, thereby ensuring appropriate operation of the operating knob 13.

The present invention is not limited by the above-mentioned embodiments and can be modified in a variety of ways without departing from the spirit and scope of the present invention.

1. A plated synthetic resin member for a vehicle comprising:
a main body molded from a translucent synthetic resin; and
a translucent plating coat formed on the surface of the main body and having a metallic gloss;
wherein the main body has a built-in lamp that can light up,
whereby, in a lighted environment, the plating coat on the surface of the main body gives off a metallic gloss, and in a darkened environment, the lamp within the main body is lit up to inform a vehicle occupant of the presence of the resin member.

2. The plated synthetic resin member for a vehicle according to claim 1, wherein the main body is an operating main body that is operated manually.

3. The plated synthetic resin member for a vehicle according to either claim 1 or claim 2, wherein the main body is molded from polycarbonate, acrylic, or Acrylonitrile Butadiene Styrene.

4. A plated synthetic resin member for a vehicle, wherein a lock release lever provided on a door of an automobile comprises a lever main body molded from a translucent synthetic resin, and a translucent plating coat formed on the surface of the lever main body that faces a vehicle compartment, wherein the lever main body comprises a built-in lamp that can light up,
whereby, in a lighted environment, the translucent plating coat on the surface of the lever main body gives off a metallic gloss, and in a darkened environment, the built-in lamp within the main body is lit up to inform a vehicle occupant of the presence of the resin member.

5. The plated synthetic resin member for a vehicle according to claim 4, wherein the lever main body is molded from polycarbonate, acrylic, or Acrylonitrile Butadiene Styrene.

6. A plated synthetic resin member for a vehicle, wherein an operating knob of an air-conditioner outlet vent device provided in an instrument panel of an automobile comprises a knob main body molded from a translucent synthetic resin, and a translucent plating coat formed on the surface of the knob main body that faces a vehicle compartment, wherein the knob main body has a built-in lamp that can light up,
whereby, in a lighted environment, the translucent plating coat on the surface of the knob main body gives off a metallic gloss, and in a darkened environment, the built-in lamp within the knob main body is lit up to inform a vehicle occupant of the presence of the resin member.

7. The plated synthetic resin member for a vehicle according to claim 6, wherein the knob main body is molded from polycarbonate, acrylic, or Acrylonitrile Butadiene Styrene.
